(19) United States
(12) Patent Application Publication
(10) Pub. No.: US 2026/0058899 A1
(43) Pub. Date: Feb. 26, 2026

(54) WIRED AND WIRELESS COMMUNICATION LINK MANAGEMENT

(71) Applicant: Charter Communications Operating, LLC, St. Louis, MO (US)

(72) Inventor: Taren G. McCullough, Plymouth, MN (US)

(21) Appl. No.: 18/809,470

(22) Filed: Aug. 20, 2024

(51) Int. Cl. H04L 45/12

(52) U.S. Cl. CPC H04L 45/124; H04L 45/123

(57) ABSTRACT

A system as discussed herein includes a communication management resource associated with a first wireless station. The communication management resource receives a data packet at the first wireless station. The data packet is destined for delivery to a second wireless station. Prior to forwarding the received data packet from the first wireless station to the second wireless station, the communication management resource analyzes performance associated with multiple communication links supporting delivery of communications between the first wireless station and the second wireless station. The multiple communication links include a wired communication link and a wireless communication link. Based on the performances, the communication management resource selects amongst the multiple communication links in which to transmit the data packet from the first wireless station to the second wireless station.

### BACKGROUND

Ethernet is a conventional physical cable connection implemented as early as in the 1980s to support transmission of data from one computer device to another. Typically, ethernet is used to support so-called local area network connections between computers and other network devices in a same physical space.

In contrast to wired communications such as those supported by ethernet, communication devices can be configured to support wireless communications. In general, multiple different wireless bands may be implemented to support wireless communications. For example, a wireless access point and corresponding one or more communication devices (such as computers) may support communications in multiple different wireless bands such as 2.4, 5, and 6 gigahertz.

In a conventional single link operation, a communication device connects with the wireless access point via one of the different wireless bands. The communication device may switch between use of the different wireless bands to communicate with the wireless access point. Other conventional communication options enable the communication device to connect to a wireless access point via use of simultaneous use of multiple wireless bands.

### BRIEF DESCRIPTION

In accordance with examples as discussed herein, a communication management resource associated with a first wireless station (first communication device) can be configured to receive a data packet destined for delivery to a second wireless station (second communication device). Assume that the first wireless station supports multiple communication links including a wired communication link and a wireless communication link between the first wireless station and the second wireless station. In such an instance, the first wireless station is able to communicate with the second wireless station via the wireless communication link or the wired communication link or both. Further in this example, the communication management resource analyzes performance associated with the multiple communication links supporting delivery of communications between the first wireless station and the second wireless station. Based on the performances, the communication management resource selects amongst the multiple communication links in which to transmit the data packet from the first wireless station to the second wireless station.

In one example, the first wireless station is a wireless access point; the second wireless station is a communication device such as a computer. Alternatively, the second wireless station is a wireless access point; the first wireless station is a communication device such as a computer.

In accordance with further examples, the communication management resource selects the wireless communication link to transmit the data packet from the first wireless station to the second wireless station in response to detecting that the wireless communication link supports better performance of conveying data to the second wireless station than the wired communication link. In such an instance, subsequent to selection, the first wireless station transmits the data packet over the wireless communication link to the wireless station.

Alternatively, the communication management resource selects the wired communication link to transmit the data packet from the first wireless station to the second wireless station in response to detecting that the wired communication link supports better performance of conveying data to the second wireless station than the wireless communication link. In such an instance, subsequent to selection, the first wireless station transmits the data packet over the wired communication link to the wireless station.

Still further examples as discussed herein include the communication management resource associated with the first wireless station implementing an upper processing layer (in a network protocol stack) to receive and process the data packet. In one example, the upper processing layer is in communication with: i) a first lower processing layer associated with the wired communication link, and ii) a second lower processing layer associated with the wireless communication link. Further in this example, the communication management resource implements the upper processing layer to process the received data packet. The upper processing layer selects the wired communication link for transmission of the data packet from the first wireless station to the second wireless station. This includes the upper processing layer forwarding the data packet to the first lower processing layer. Via the first lower processing layer in the first wireless station, the first wireless station then communicates the data packet over the wired communication link.

Accordingly, the wired communication link as discussed herein provides a bypass path with respect to the wireless communication link for communicating the data packet from the first wireless station to the second wireless station. On the other hand, the wireless communication link provides a bypass path with respect to the wired communication link for communicating the data packet from the first wireless station to the second wireless station.

In accordance with another example as discussed herein, the wired communication link is a wired local area network supporting ethernet. The first wireless station can be configured as a first terminal node in the wired local area network; the second wireless can be configured as a second terminal node in the wired local area network. Other communication devices can be connected to the wired local area network.

Yet further examples as discussed herein include the communication management resource or other suitable entity associated with the first wireless station monitoring a respective performance associated with each of the multiple communication links. The communication management resource can be configured to produce the performance information such that it ranks the multiple communication links based on the respective performance. The communication management resource analyzes the performance information and corresponding ranking to determine which of the multiple communication links provides a best performance of communicating between the first wireless station and the second wireless station. As previously discussed, the communication management resource can be configured to control the first wireless station to communicate over a respective one of the multiple communication links (wired or wireless) depending upon which of the communication links provides the best performance of conveying data between the first wireless station and the second wireless station.

Techniques as discussed herein are useful over conventional techniques. For example, one or more implementation of a communication management resource and corresponding operations as discussed herein provide better use of one or more networks to more efficiently convey data.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable hardware storage medium (or computer-readable storage hardware) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes computer readable storage hardware having instructions stored thereon. The instructions, when executed by corresponding computer processor hardware, cause the computer processor hardware (such as one or more co-located or disparately processor devices or hardware) to: receive a data packet at a first wireless station, the data packet destined for delivery to a second wireless station; analyze performance associated with multiple communication links supporting delivery of communications between the first wireless station and the second wireless station, the multiple communication links including a wired communication link and a wireless communication link; and based on the performances, select amongst the multiple communication links in which to transmit the data packet from the first wireless station to the second wireless station.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of controlling conveyance of data packets in a network environment including multiple available communication links. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment including a wireless access point supporting a wireless communication link and a wired communication link as discussed herein.

FIG. 2 is an example diagram illustrating a network environment including a wireless access point supporting a wireless communication link and a wired communication link as discussed herein.

FIG. 3 is an example diagram illustrating a network environment supporting a combination of a wired communication link and one or more wireless communication links with each of multiple communication devices as discussed herein.

FIG. 4 is an example diagram illustrating conveyance of communications between a first wireless station and a second wireless station to set up multiple communication links as discussed herein.

FIG. 5 is an example diagram illustrating aggregation/use of different wired/wireless communication links to support conveyance of communications as discussed herein.

FIG. 6 is an example diagram illustrating use of multiple different communication links at different times as discussed herein.

FIG. 7 is an example diagram illustrating simultaneous use of wired and wireless communication links supporting conveyance of data between a first wireless station of the second wireless station as discussed herein.

FIG. 8 is an example diagram illustrating implementation of an arbiter function supporting conveyance of data in a downlink direction from the first wireless station over wired/wireless communication links to a second wireless station as discussed herein.

FIG. 9 is an example diagram illustrating implementation of a host processor function supporting conveyance of data over the different communication interfaces as discussed herein.

FIG. 10 is an example diagram illustrating a so-called inter-chip bus option as discussed herein.

FIG. 11 is an example diagram illustrating example computer hardware and software operable to execute operations as discussed herein.

FIG. 12 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A system as discussed herein includes a communication management resource associated with a first wireless station. The communication management resource receives a data packet (such as communication with data) at the first wireless station.

The data packet is destined for delivery to a second wireless station. In furtherance of forwarding the received data packet from the first wireless station to the second wireless station, the communication management resource analyzes performance associated with multiple communication links supporting delivery of communications between the first wireless station and the second wireless station. The multiple communication links include a wired communication link and a wireless communication link. Based on the performances, the communication management resource selects amongst the multiple communication links in which to transmit the data packet from the first wireless station to the second wireless station.

Note that the communication management resource can be configured to transmit the data packet over the wired communication link in response to detecting that the wired communication link provides a better performance than the wireless communication link of conveying communications from the first wireless station to the second wireless station. Alternatively, the communication management resource can be configured to transmit the data packet over the wireless communication link in response to detecting that the wireless communication link provides a better performance than the wired communication link of conveying communications from the first wireless station to the second wireless station.

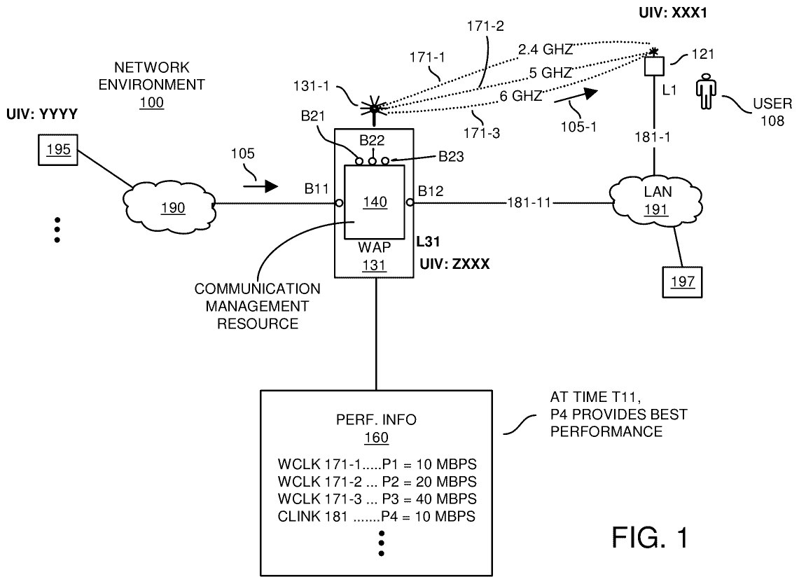

Now, more specifically, with reference to the drawings, FIG. 1 is an example diagram illustrating a network environment including a wireless access point supporting a wireless communication link and a wired communication link as discussed herein.

As shown in FIG. 1, the network environment 100 can be configured to include wireless access point 131 (such as a first wireless station) and communication device 121 (such as a second wireless station and wired station). The network environment 100 can be configured to include remote network 190 as well as network 191.

In this example, the communication device 121 is operated by the user 108. The communication device 121 may be stationary (a.k.a., non-moving, location L1, etc.) or mobile in the network environment 100.

Remote network 190 can be configured to include any suitable wired or wireless networks or resources or components to support communications as discussed herein such as between the communication device 121 and the server resource 195.

Each of the wireless communication links 171-1, 171-2, and 171-3, can be configured to support any suitable wireless communication protocol. In one example, each of the wireless communication links supports one or more 802.11 protocols, one or more Wi-Fi™ protocols, etc.

Each of the wireless access point and the communication device 121 can be configured to implement a listen before talk function prior to wirelessly transmitting over any of the wireless communication links.

In one example, the network 191 is a so-called local area network such as an ethernet supporting one or more ethernet protocols. The wireless access point 131 can be configured to include one or more instances of network hardware providing physical interconnection between the wireless access point 131 and the communication device 121. For example, the physical interconnection between the wireless access point 131 in the communication device (such as a computer or other suitable resource) includes the wired communication link 181-11, local area network 191, and the wired communication link 181-1. The port B11 (communication interface) of the communication management resource 140 or wireless access point 131 is configured to receive communications from and transmit communications to the remote network 190. The port B12 (communication interface) is configured to receive communications from and transmit communications to the remote network 191 over the wired communication link 181-11.

Thus, the physical interconnection between the wireless access point 131 and the communication device 121 may be or include a wired local area network, where the wireless access point 131 is a first terminal node in the wired local area network, the communication device 121 is a second terminal node in the wired local area network, and so on. As further shown, the communication device 197 is connected to a third terminal node of the wired local area network 191.

Thus, the wired communication link 181 as discussed herein includes one or more of the wired communication link 181-11, local area network 191, and/or wired communication link 181-1.

Note that each of the resources as discussed herein can be configured as communication hardware, communication software, or a combination of communication hardware and communication software. More specifically, the communication management resource 140 can be configured as communication management hardware, communication management software, or a combination of communication management hardware and communication management software; communication device 121 can be configured as communication management hardware, communication management software, or a combination of communication management hardware and communication management software; and so on.

The wireless access point 131 can be configured with one or more ports to support conveyance of data between the remote network 190 and the communication device 121.

As further shown, the communication management resource 140 and corresponding wireless access point 131 includes multiple ports (communication interfaces) to receive and forward (generally control) conveyance of communications in an uplink and downlink direction. Controlled conveyance of communications may include determining which of the multiple communication links provides the best performance of conveying respective data to a destination device.

For example, the wireless access point 131 and corresponding communication management resource 140 includes: port B11 (communication interface) to receive communications from and transmit communications to the remote network 190, port B12 (communication interface) to receive communications from and transmit communications to the network 191, port B21 (communication interface) to receive communications from and transmit communications over the wireless communication link 171-1 (such as supporting a 2.4 GHz protocol), port B22 (communication interface) to receive communications from and transmit communications over the wireless communication link 171-2 (such as supporting a 5 GHz protocol), port B23 (communication interface) to receive communications from and transmit communications over the wireless communication link 171-3 (such as supporting a 6 GHz protocol).

Each of the different communication links may be considered bypass communication links with respect to each other. For example, the wired communication link 181 provides a bypass path (wired path between the port B12 of the communication management resource 140 and the wireless access point 131 to the communication device 121) with respect to any of the wireless communication links 171-1, 171-2, and 171-3, for communicating the data packet 105 from the wireless access point 131 to the communication device 121.

Assume further in this example that the server resource 195 is assigned the network address or unique identifier value YYYY; wireless access point 131 is assigned the network address or unique identifier value ZXXX; communication device 121 is assigned the network address or unique identifier value XXX1.

The unique identifier values assigned to the different entities in the network environment 100 facilitate conveyance of respective communications via data packet routing.

Note that forwarding of the respective data packets over the one or more communication links between the wireless access point 131 and the communication device 121 may be based upon a respective performance associated with each of the different communication links.

In one example, the communication management resource 140 or other suitable entity in the network environment 100 continuously monitors a respective performance associated with each of the multiple communication links. The communication management resource 140 or other suitable entity produces the performance information 160 indicating the detected performances at any given time. In a further example as discussed herein, the performance information 160 indicates a ranking of the multiple communication links based on their respective performance.

Note that the performance information 160 can be configured to indicate any suitable performance attributes associated with the different communication links. Such monitored performance attributes may include maximum data rate transmission for bandwidth supported by a respective communication link at a particular time, the bit error rate associated with transmitting data information over a respective communication link at a particular time, availability of bandwidth to transmit data over the respective communication link to transmit, etc.).

For example, the performance information 160 at time T11 indicates that the wireless communication link 171-1 provides the performance P1 for conveying respective communications; the performance information 160 indicates that the wireless communication link 171-2 provides the performance P2 for conveying respective communication; the performance information 160 indicates that the wireless communication link 171-3 provides the performance P3 for conveying respective communications; the performance information 160 indicates that the wired communication link 181 provides the performance P4 for conveying respective communication.

When forwarding data packet 105 (destined for delivery to the communication device 121) received at the port B11, the communication management resource 140 analyzes the performance information 160 to determine which of the multiple communication links provides a best performance of communicating data packets between the wireless access point 131 and the communication device 121.

As a more specific example, assume that the wireless access point 131 and corresponding communication management resource 140 receive a data packet (a.k.a., communication including data) at communication port B11 of the wireless access point 131. The data packet 105 is destined for delivery to the communication device 121.

In response to receiving the data packet 105, the communication management resource 140 analyzes the performance information 160 at time T11 to determine a respective performance associated with each of the communication links (wireless communication link 171-1, wireless communication link 171-2, wireless communication link 171-3, wired communication link 181) supporting delivery of communications between the wireless access point 131 and the communication device 121.

As previously discussed, the available communication links to transmit the data packet 105 from the wireless access point 131 to the communication device 121 include wireless communication link 171-1, wireless communication link 171-2, wireless communication link 171-3, wired communication link 181.

Based on the performances as indicated by the performance information 160 such as performance P1 (supporting a data conveyance rate of 10 megabytes per second at or around time T11) associated with the wireless communication link 171-1, performance P2 (supporting data conveyance rate of 20 megabytes per second at or around time T11) associated with the wireless communication link 171-2, performance P3 (supporting a data conveyance rate of 40 megabytes per second at or around time T11) associated with the wireless communication link 171-3, and performance P4 (supporting a data conveyance rate of 10 megabytes per second at or around time T11) associated with the physical communication link 181, the communication management resource 140 selects amongst the multiple communication links in which to transmit the data packet 105 from the wireless access point 131 to the communication device 121.

In this example, assume that the communication management resource 140 determines that the wireless communication link 171-3 provides performance P3, which is determined by the communication management resource 140 to be better than performance provided by wireless communication link 171-1 (P1), wireless communication link 171-2 (P2), and wired communication link 181 (P4). In other words, the communication management resource 140 determines that the wireless communication link 171-3 provides the best data throughput to the communication device 121 out of all the possible available communication links.

In such an instance, the communication management resource 140 selects the wireless communication link 171-3 to transmit the data packet 105 from port B23 and the corresponding antenna hardware 165 of the wireless access point 131 to the communication device 121 as wireless communications such as data packet 105-1. More specifically, as further shown, the communication management resource 140 transmits the communications 105-1 (such as data packet 105 or wireless version of the data packet 105) out of port B23 over the wireless communication link 171-3 to the communication device 121.

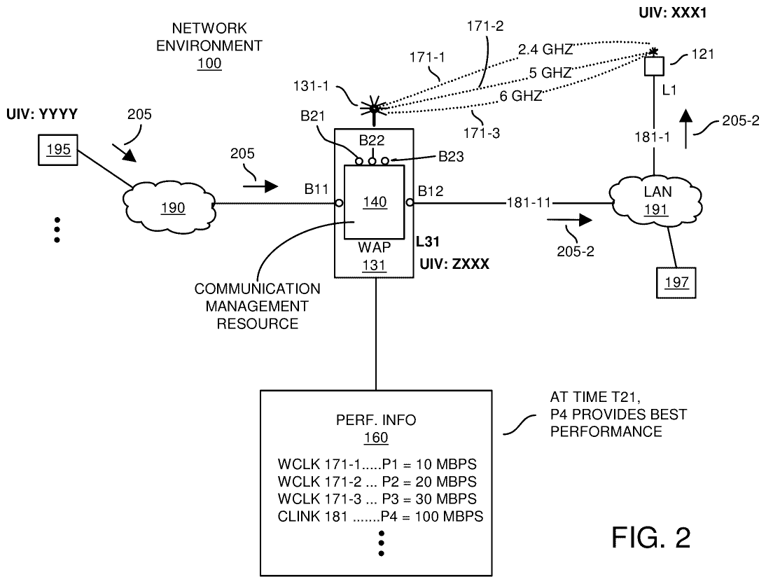

An example of transmitting the received data packet over the wired communication link as further discussed in FIG. 2.

FIG. 2 is an example diagram illustrating a network environment including a wireless access point supporting a wireless communication link and a wired communication link as discussed herein.

As another example, assume that the wireless access point 131 and corresponding communication management resource 140 receive a data packet 205 (a.k.a., communication including data) at communication port B11 of the wireless access point 131 at or around time T21. The data packet 205 is destined for delivery through the wireless access point 131 to the communication device 121.

In response to receiving the data packet 205, the communication management resource 140 analyzes the performance information 160 at time T21 to determine a respective performance associated with each of the communication links (wireless communication link 171-1, wireless communication link 171-2, wireless communication link 171-3, wired communication link 181) supporting delivery of communications between the wireless access point 131 and the communication device 121.

As previously discussed, the available communication links to transmit the data packet 205 from the wireless access point 131 to the communication device 121 include wireless communication link 171-1, wireless communication link 171-2, wireless communication link 171-3, wired communication link 181.

Based on the performances as indicated by the performance information 160 such as performance P1 (supporting data conveyance rate of 10 megabytes per second at or around time T21) associated with the wireless communication link 171-1, performance P2 (supporting data conveyance rate of 20 megabytes per second at or around time T21) associated with the wireless communication link 171-2, performance P3 (supporting data conveyance rate of 30 megabytes per second at or around time T21) associated with the wireless communication link 171-3, and performance P4 (supporting data conveyance rate of 100 megabytes per second at or around time T21) associated with the physical communication link 181, the communication management resource 140 selects amongst the multiple communication links in which to transmit the data packet 205 from the wireless access point 131 to the communication device 121.

In this example, assume that the communication management resource 140 determines that the wired communication link 181 provides performance P4 (100 megabits per second), which is better than performance provided by wireless communication link 171-1 (P1), wireless communication link 171-2 (P2), and wireless communication link 171-3 (P3). In other words, the wired communication link 181 provides the highest available bandwidth to transmit the data packet 205 over the wired communication link 181 to the communication device 121.

In such an instance, the communication management resource 140 selects the wired communication link 181 to transmit the data packet 205 through the port B12 from over the communication link 181 from the wireless access point 131 to the communication device 121 as wired communications or data packet 205-1. More specifically, as further shown, the communication management resource 140 transmits the communications 205-1 (such as data packet 205) out of port B12 over the wired communication link 181-11 and the network 191 (wired communication link 181) to the communication device 121.

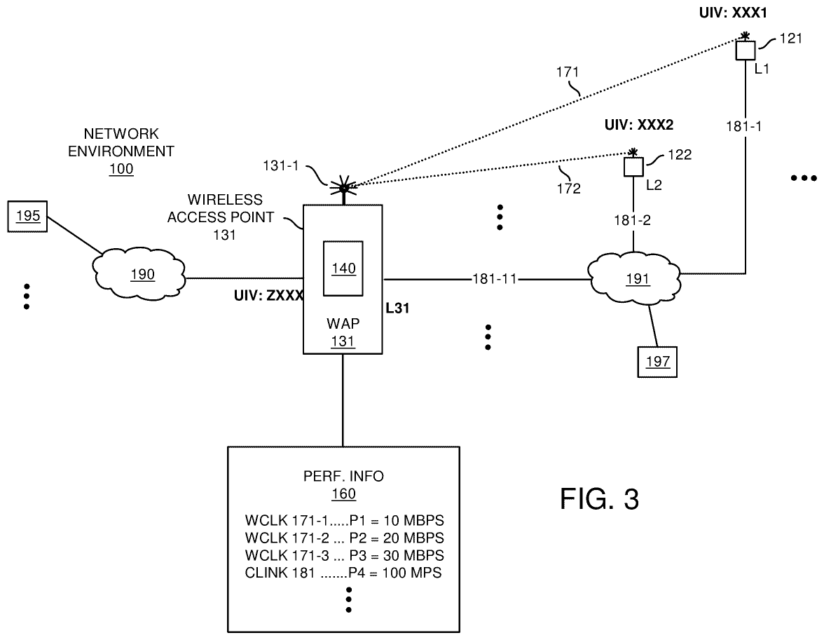

FIG. 3 is an example diagram illustrating a network environment supporting the combination of a wired communication link and one or more wireless communication links with each of multiple communication devices as discussed herein.

In this example, as previously discussed, the wireless access point 131 supports one or more wireless communication links 171 and a wired communication link 181 between the wireless access point 131 in the communication device 121.

Additionally, in the example shown in FIG. 3, the wireless access point 131 supports one or more wireless communication links 172 and a wired communication link 181 between the wireless access point 131 and the communication device 121.

In a similar manner as previously discussed, depending upon the performance of each of the different communication links, the wireless access point 131 transmits data received from the remote network 190 to each of the communication devices 121 and 122.

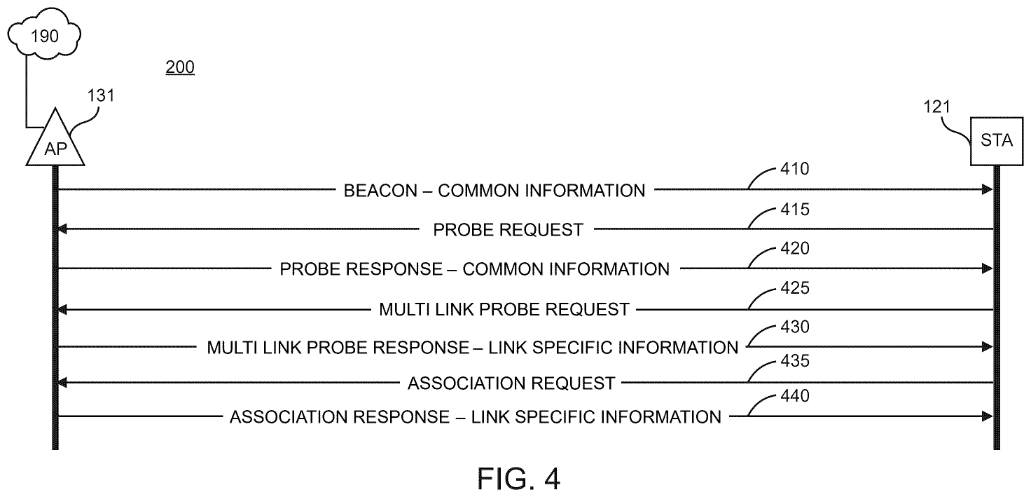

FIG. 4 is an example diagram illustrating conveyance of communications between a first wireless station and a second wireless station to set up multiple communication links as discussed herein.

In this example, the wireless access point 131 is configured to broadcast availability of different wireless services and/or wired services provided by the wireless access point 131 in the network environment 100.

For example, as shown in communication flow 400 in FIG. 4, the wireless access point 131 transmits a wireless communication 410 to any wireless devices in its wireless range. Assume in this example that the communication device 121 (such as a wireless station) receives the communications 410. In one example, the communications 210 indicate information such as an identity of the wireless access point 131 and its availability to provide wireless or wired services.

Assume that the communication device 121 (such as a second wireless station) desires to establish connectivity with the wireless access point 131 (such as a first wireless station) as shown in FIG. 1. In one example, the eventually established connectivity between the wireless access point 131 and the communication device 121 supports conveyance of respective data in the downlink direction via communications transmitted from the network 190 through the wireless access point 131 to the communication device. In a reverse direction (uplink direction), the eventually established connectivity between the communication device and the wireless access point supports conveyance of a respective data in the uplink direction via communications transmitted from the communication device 121 over the connectivity through the wireless access point 131 to the network 190.

To learn of availability of the different types of available communication links, the communication device 121 transmits communications 415 to the wireless access point 131. In one example, the communications 415 include a probe request inquiring as to the different wired or wireless services provided by the wireless access point 131.

In response to receiving the communications 415, the wireless access point 131 transmits communications 420 (such as a probe response) from the wireless access point 131 to the mobile communication device 121. The communications 415 can be configured to include any suitable information and indicate the different types of wired (such as ethernet supporting ethernet protocols) and wireless communication links (such as a first wireless communication protocol supporting 2.4 GHz, a second wireless communication protocol supporting 5 GHz, a third wireless communication protocol 6 GHz) supported by the wireless access point 131. Accordingly, the mobile communication device 121 can be configured to learn of availability of the wired communication link 181 (such as a local area network) via communications 420 wirelessly transmitted by the wireless access point 131. Alternatively, the mobile communication device 121 can be configured to communicate with the wireless access point 131 over the wired communication link 181 to learn of availability of the wired communication link 181 and use of the wired communication link 181 in conjunction with any of the wireless communication links 171 between the wireless access point 131 and the communication device 121.

As further shown, the communication device 121 can be configured to transmit the communications 425 including a multi-link probe request to the wireless access point 131.

In response to receiving the communications 425, the wireless station 131 transmits the communications 430 including a multi-link probe response including link specific information to establish the communication links including the wireless communication link 171-1, wireless communication link 171-2, wireless communication link 173-3, and the wired communication link 181.

Via communications 435, the communication device 121 transmits an association request to the wireless access point 131. In response to receiving the communications 435, the wireless access point 131 transmits an association response including information to set up the communication links between the wireless access point 131 and the communication device 121.

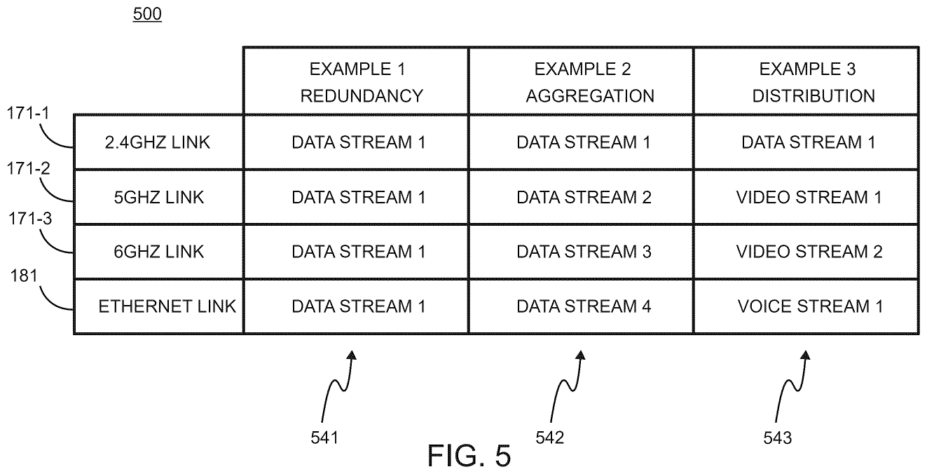

FIG. 5 is an example diagram illustrating aggregation of different wired/wireless communication links to support conveyance of communications as discussed herein.

As previously discussed, the different communication links supported by the wireless access point 131 can be used in any number of ways for communication of data between the wireless access point 131 and the communication device 121.

For example, via configuration 541, the wireless access point 131 can be configured to support redundancy of a given data stream over each of the different communication links.

More specifically, via implementation of the configuration information 541, the wireless access point 131 can be configured to receive the data stream #1 (one or more data packets) at port B11 from any suitable resource in the remote network 190. Via the configuration 541, the wireless access point 131 transmits a first instance of the data stream #1 through port B21 over the wireless communication link 171-1 to the communication device 121; the wireless access point 131 transmits a second instance of the data stream #1 through port B22 over the wireless communication link 171-2 to the communication device 121; the wireless access point 131 transmits a third instance of the data stream #1 through port B23 over the wireless communication link 171-3 to the communication device 121; the wireless access point 131 transmits a fourth instance of the data stream #1 through port B12 over the wired communication link 181 to the communication device 121. Thus, the configuration 541 supports redundancy of transmitting the respective data stream #1 from the wireless access point 131 to the communication device 121.

Via configuration 542, the wireless access point 131 can be configured to support conveyance of different data streams over each of the different communication links.

For example, the wireless access point 131 can be configured to receive multiple data streams (from the remote network 190 through the port B11) such as data stream #1, data stream #2, data stream #3, data stream #4, from any suitable one or more resources. Each of the data streams may be of the same type of data such as video data, voice data, webpage data, etc. Via the configuration 542, the wireless access point 131 transmits data stream #1 over the wireless communication link 171-1 to the communication device 121; the wireless access point 131 transmits the data stream #2 over the wireless communication link 171-2 to the communication device 121; the wireless access point 131 transmits data stream #3 over the wireless communication link 171-3 to the communication device 121; the wireless access point 131 transmits the data stream #4 over the wired communication link 181 (combination of wired communication link 181-11, network 191, and wired communication link 181-1) to the communication device 121. Thus, the configuration 542 supports simultaneous transmission of multiple different data streams from the wireless access point 131 to the communication device 121.

Via configuration 543, the wireless access point 131 can be configured to support conveyance of different types of data streams over each of the different communication links.

For example, the wireless access point 131 can be configured to receive multiple information or data streams such as webpage data stream #1, video data stream #1, video stream #2, and voice data stream #1 (audio data stream) from any suitable one or more resources. Via the configuration 543, the wireless access point 131 transmits webpage data stream #1 over the wireless communication link 171-1 to the communication device 121; the wireless access point 131 transmits the video data stream #1 over the wireless communication link 171-2 to the communication device 121; the wireless access point 131 transmits the video data stream #2 over the wireless communication link 171-3 to the communication device 121; the wireless access point 131 transmits the voice stream #1 over the wired communication link 181 to the communication device 121. Thus, the configuration 543 supports simultaneous transmission of multiple different data stream types from the wireless access point 131 to the communication device 121 over the different wired and wireless communication links.

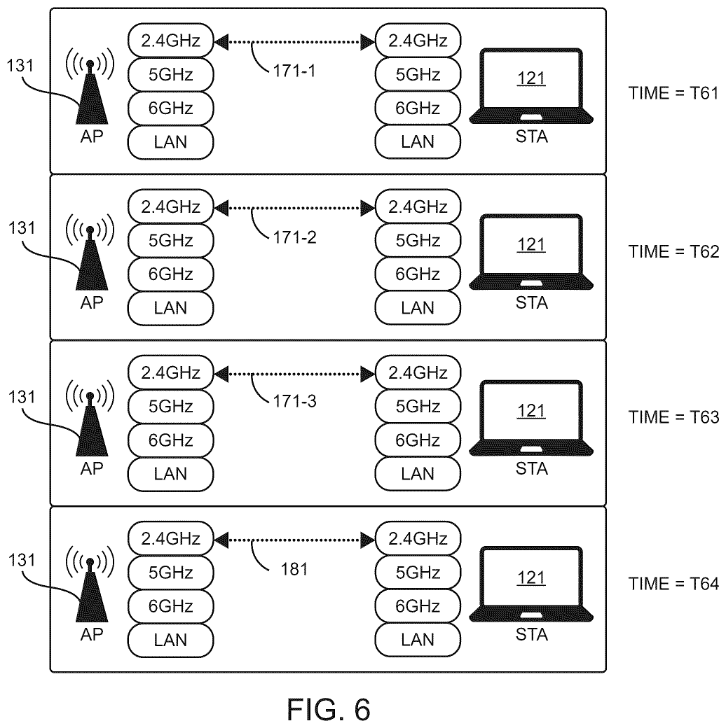

FIG. 6 is an example diagram illustrating use of multiple different communication links at different times as discussed herein.

The different examples as shown in FIG. 6 illustrate how the communication system as discussed herein can be configured to support use of the different communication links at different times depending upon provided performance.

For example, assume that the wireless access point 131 monitors the performance of the different available wired and wireless communication links over time to determine which of the links (wired or wireless) provides the best performance (such as highest data rate transmission, fewer bit rate errors of transmitting data, etc.) of conveying data from the wireless access point 131 to the communication device 121. Assume further that the wireless access point 131 determines that the wireless communication link 171-1 provides the best performance at or around time T61. In such an instance, the wireless access point 131 selects communication link 171-1 for transmission of corresponding data from the wireless access point 131 to the communication device 121.

Assume further that the wireless access point 131 determines that the wireless communication link 171-2 provides the best performance (such as highest data rate transmission, fewer bit rate errors of transmitting data, etc., of conveying data) at or around time T62. In such an instance, the wireless access point 131 selects communication link 171-2 for transmission of corresponding data from the wireless access point 131 to the communication device 121.

Assume further that the wireless access point 131 determines that the wireless communication link 171-3 provides the best performance (such as highest data rate transmission, fewer bit rate errors of transmitting data, etc., of conveying data) at or around time T63. In such an instance, the wireless access point 131 selects communication link 171-3 for transmission of corresponding data from the wireless access point 131 to the communication device 121.

Assume further that the wireless access point 131 determines that the wired communication link 181 provides the best performance (such as highest data rate transmission, fewer bit rate errors of transmitting data, etc., of conveying data) at or around time T64. In such an instance, the wireless access point 131 selects communication link 181 for transmission of corresponding data from the wireless access point 131 to the communication device 121.

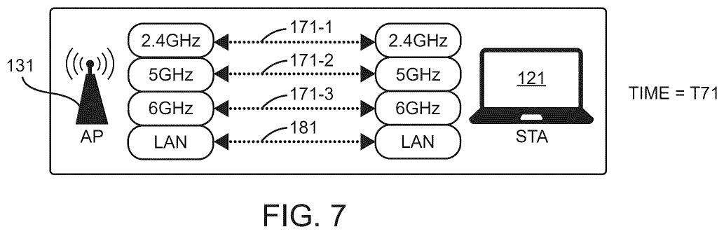

FIG. 7 is an example diagram illustrating simultaneous use of wired and wireless communication links supporting conveyance of data between a first wireless station of the second wireless station as discussed herein.

As previously discussed, the wireless stations such as wireless access point 131 or the communication device 121 can be configured to support simultaneous transmission of data over multiple communication links such as wireless communication link 171-1, wireless communication link 171-2, wireless communication link 171-3, and wired communication link 181.

In this example, at around time T71, assume that the wireless access point 131 requires sufficient bandwidth to communicate data from the wireless access point 131 to the communication device 121. Assume further that none of the communication links individually has an ability to support a sufficiently high bandwidth to convey the data. In such an instance, the wireless access point 131 can be configured to acquire multiple communication links and then simultaneously transmit respective data from the wireless access point 131 to the communication device 121 over those acquired communication links.

For example, via a respective listen before talk function for each wireless communication link, the wireless access point 131 can be configured to acquire wireless communication link 171-1, wireless communication link 171-2, wireless communication link 171-3. The wireless access point 131 then simultaneously transmits different portions of data over each of the different communication links. For example, the wireless access point 131 simultaneously transmits first data over the wireless communication link 171-1 to the communication device 121, second data over the wireless communication link 171-2 to the communication device 121, third data over the wireless communication link 171-3 to the communication device 121, and fourth data over the wired communication link 181 to the communication device 121.

Note further that the communication links between the wireless access point 131 and the communication device 121 may support full-duplex communications. For example, the wireless access point 131 may acquire use of the wireless communication link 171-1 and wireless communication link 171-2 to communicate and a downstream direction from the wireless access point 131 to the communication device 121. The communication device 121 may acquire use of wireless communication link 171-3 and use the wired communication link 181 to communicate in an uplink direction from the communication device 121 to the wireless access point 131. In such an instance, the wireless access point 131 can be configured to simultaneously transmit first data over the wireless communication link 171-1 and the wireless communication link 171-2 to the communication device 121 while the communication device 121 simultaneously communicates second data over a combination of the wireless communication link 171-3 and the wired communication link 181 to the wireless access point 131.

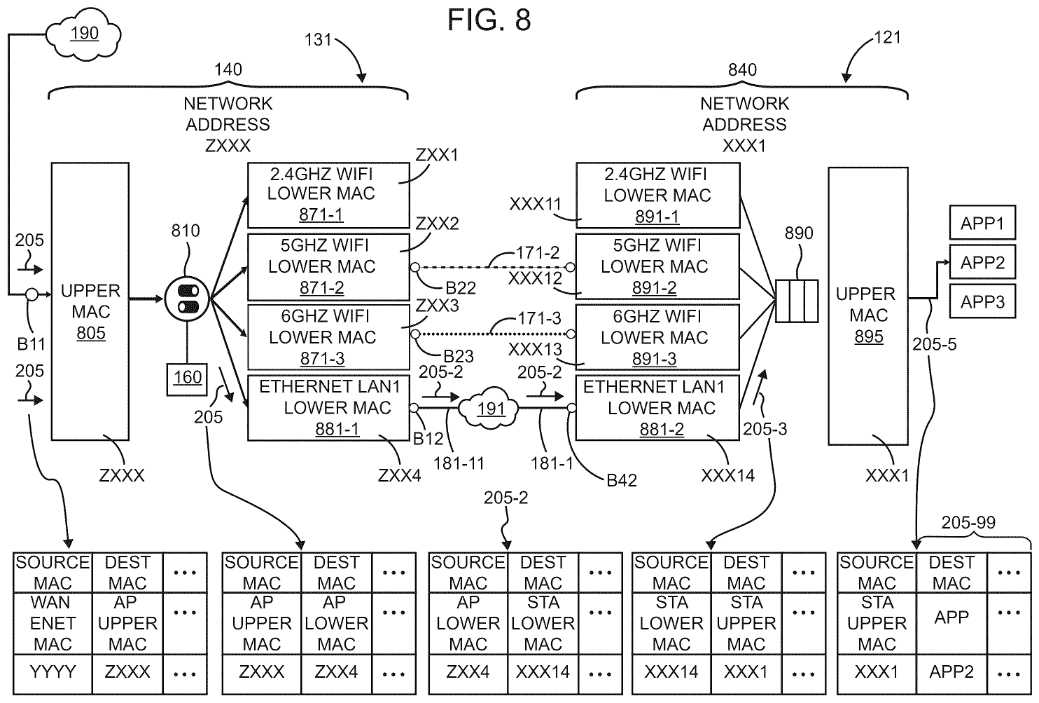

FIG. 8 is an example diagram illustrating implementation of multiple arbiter functions and upper/lower layer processing functions supporting conveyance of data through a wireless access point as discussed herein.

As shown in FIG. 8, the communication management resource 140 includes the upper network layer processing function 805 assigned network address ZXXX, arbiter 810, communication interface 871-1 assigned network address ZXX1, communication interface 871-2 assigned network address ZXX2, communication interface 871-3 assigned network address ZXX3, and communication interface 881-1 assigned network address ZXX4.

As further shown, the communication management resource 840 associated with the communication device 121 includes the upper network layer processing function 895 assigned network address XXX1, queue 890, communication interface 891-1 assigned network address XXX11, communication interface 871-2 assigned network address XXX12, communication interface 871-3 assigned network address XXX13, and communication interface 881-2 assigned network address XXX14.

In this example, assume that the data packet 205 includes or has a source network address of YYYY (such as source MAC address) indicating that it was sent by the server 195 to the wireless access point 131. The server 195 can be configured to target transmission of the data packet 205 to a specific application such as application APP2 of the communication device 121 or simply wireless access point 131 which knows to forward it to the application APP2 associated with the communication device 121.

In this example, the data packet 205 further includes the destination network address ZXXX assigned to the upper network layer processing function 805 associated with the communication device 121. As its name suggests, the destination network address ZXXX indicates that the data packet 205 is destined for delivery to the upper network layer processing function 805 of the communication device 121. Assume further in this example that the data packet 205 and corresponding data payload is directed for delivery to the application APP2 executed on the mobile communication device 121.

Note that the components as discussed herein can be implemented in any suitable manner. In one example, the upper network layer processing function 805 (of a network layer protocol stack) is or includes an upper MAC (Media Access Control) layer data packet processing function; the communication interface 871-1 is or includes a first lower layer data packet processing function such as a lower layer MAC (Media Access Control) function associated with the wireless communication link 171-1 (2.4 GHz); the communication interface 871-2 is or includes a second lower layer data packet processing function such as a lower layer MAC (Media Access Control) function associated with the wireless communication link 171-2 (5 GHz); the communication interface 871-3 is or includes a third lower layer data packet processing function such as a lower layer MAC (Media Access Control) function associated with the wireless communication link 171-3 (6 GHz); the communication interface 881-1 is or includes a fourth lower layer data packet processing function such as an ethernet lower layer MAC (Media Access Control) function associated with the wired communication link 181-11 (ethernet link).

Note that the upper layer MAC function (such as upper layer processing function 805) can be configured to implement higher-level functions such as network management, security, and quality of service, while the lower layer processing functions such as lower layer MAC functions (871-1, 871-2, 871-3, 881-1) can be configured to implement physical-layer functions such as channel access and medium sharing associated with the wireless communication links 171-1, 171-2, 171-3, 181-1, etc.

Accordingly, techniques herein include implementing an upper layer processing function such as the upper network layer processing function 805 at the wireless access point 131 to receive and process the data packet 205.

As shown in FIG. 8, the upper network processing layer function 805 is in communication with each of the lower processing layers such as a lower layer processing function 881-1 associated with the wired communication link 181, lower layer processing function 871-3 associated with the wireless communication link 171-3, and lower layer processing function 871-2 associated with the wireless communication link 171-2.

The upper layer processing function 805 of the wireless access point 131 processes the received data packet 205 and forwards it to the arbiter 810. In a similar manner as previously discussed, the arbiter 810 receives the data packet 205 from the upper layer processing function 805 and uses the performance information 160 as a basis in which to select amongst the lower layer processing functions and corresponding available communication links to forward the received data packet 205 to the communication device 121.

In this example, similar to FIG. 2, assume that the arbiter 810 determines from the performance information 160 that the wired communication link 181 is the best path (least congested) in which to forward the data packet 205 and corresponding data payload to the communication device 121 operated by the user 108. In such an instance, the arbiter 810 selects the wired communication link 181 (such as 181-11) for transmission of the data packet 205 from the wireless access point 131 to the communication device 121. In such an instance, the arbiter 810 converts the data packet 205 into the data packet 205-1 in which the source network address is switched from YYYY to ZXXX and the destination network address is switched from ZXXX to ZXX4. The network address ZXX4 is assigned to the lower network layer processing function 881-1.

The upper network layer processing function 805 then forwards the data packet 205-1 to the arbiter 810.

As previously discussed, the arbitrator 810 uses the performance information 160 to determine which of the multiple the multiple available (established) communication links to forward the data packet 205-1 to the communication device 121.

In this example, based upon the performance information 160, the arbiter 810 chooses the wired communication link 181 and corresponding lower network layer processing function 881-1 and thus forwards the received data packet 205-1 to the lower processing layer function 881-1 assigned the network address ZXX4.

The lower processing layer function 881-1 converts the received data packet 205-1 into the data packet 205-2 and forwards the data packet 205-2 through the port B12 over the wired communication link 181 to the communication device 121. Prior to forwarding, it is noted that the lower network layer processing function 881-1 converts the data packet 205-1 into the data packet 205-2 in which the source network address is switched from ZXXX to ZXX4 and the destination network address is switched from ZXX4 to XXX14. As previously discussed, the lower network layer processing function 881-2 associated with the communication device 121 is assigned the network address XXX14.

As further shown, the communication device 121 includes the communication management resource 840. Communication management resource 840 includes the port B42 associated with the lower network layer processing function 881-2 to process the data packet 205-2 received over the wired communication link 181.

The lower network layer processing function 881-2 converts the received data packet 205-2 into the data packet 205-3 in which the source network address is switched from ZXX4 to XXX14 and the destination network address is switched from XXX14 XXX1.

The lower network layer processing function 881-2 forwards the data packet 205-3 to the queue 890. The queue 890 stores the data packet 205-3 received from the lower layer processing function 881-2 and forwards it to the upper layer processing function 895 associated with the communication management resource 840 of the communication device 121. As previously discussed, the upper network layer processing function 895 is assigned the network address XXX1.

The upper network layer processing function 895 converts the received data packet 205-3 into the data packet 205-5 in which the source network address is switched from XXX14 to XXX1 and the destination network address is switched from XXX1 to any suitable value such as the destination APP2 in data field 205-99.

The upper layer processing function 895 determines from the data packet 205-3 which of multiple applications in the communication device 121 the data packet 205-3 is directed. Assume that data packet 205-3 (as indicated by the data field 205-99) indicates that the data payload in the data packet 205-5 is directed to the application APP2 on the mobile communication device 121. In such an instance, the upper layer processing function 895 forwards the received data packet 205-5 to the target application APP2.

Accordingly, a wired communication link 181 can be used as a bypass path with respect to a wireless communication link 171-3 to convey communications (data packets) from a wireless access point 131 to a target communication device 121.

Note further that the data packets 205, 205-1, 205-2, 205-3, 205-5, etc., each include the data payload sent by the server resource 195 to the application APP2 of the communication device 121. Thus, each of the data packets is generally the same except for switching of the source network address and destination network address as the data packet 205 is forwarded to the communication device 121.

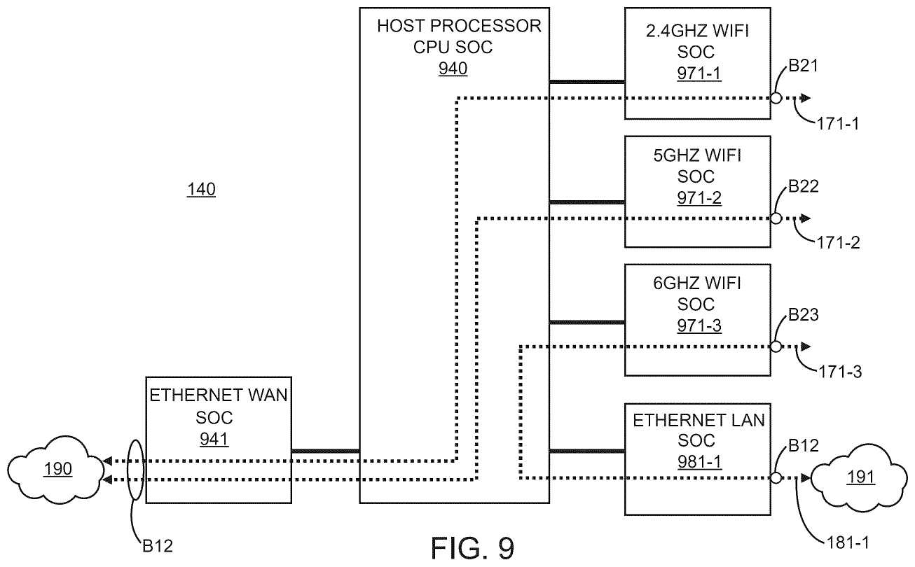

FIG. 9 is an example diagram illustrating implementation of a host processor function supporting conveyance of data over the different communication interfaces as discussed herein.

In this example, the communication management resource 140 includes multiple components such as the communication interface 941, host processor 940, communication interface 971-1, communication interface 971-2, communication interface 971-3, and communication interface 981-1.

Note that the communication interfaces associated with the communication management resource 140 can be configured in any suitable manner. In one configuration, each of the communication interfaces is implemented or includes a system-on-a-chip hardware and/or software to support communications as discussed herein.

As further shown in this example, as previously discussed, the communication management resource 140 and corresponding wireless access point 131 can be configured to include the port B11 and corresponding communication interface 941 to receive communications from remote network 190 as well as transmit communications to the remote network 190.

The communication management resource 140 can be configured to include the port B21 and corresponding communication interface 971-1 to receive communications from communication device 121 over the wireless communication link 171-1. The port B21 and corresponding communication interface 971-1 also can be configured to support transmission of communications over the wireless communication link 171-1.

The communication management resource 140 can be configured to include the port B22 and communication interface 971-2 to receive communications from communication device 121 over the wireless communication link 171-2. The port B22 and communication interface 971-2 also can be configured to support transmission of communications over the wireless communication link 171-1.

The communication management resource 140 can be configured to include the port B23 and communication interface 971-3 to receive communications from communication device 121 over the wireless communication link 171-3. The port B23 and communication interface 971-3 also can be configured to support transmission of communications over the wireless communication link 171-3.

The communication management resource 140 can be configured to include the port B12 and communication interface 981-1 to receive communications from communication device 121 over the wired communication link 181-1. The port B12 and communication interface 981-1 also support transmission of communications over the wireless communication link 181-1.

In this example, the host processor 940 associated with the communication management resource 940 can be configured to control the flow of communications in and out of the different ports.

For example, the communication interface 941 can be configured to receive communications from the remote network 190 through the port B11. The host processor 940 forwards the received communications through any of the communication interfaces 971-1, 971-2, 971-3, and 981-1 to a destination such as the communication device 121.

Any of the communication interfaces 971-1, 971-2, 971-3, and 981-1 may receive communications transmitted by the communication device 121. The host processor 940 forwards the received communications through the communication interface 941 and the port B11 to a destination in the remote network 190. Alternatively, the host processor 940 can be configured to forward any communications received from the communication interfaces 971-1, 971-2, 971-3, through the communication interface 981-1 and the port B12 to a communication device in the local area network 191 such as communication device 197.

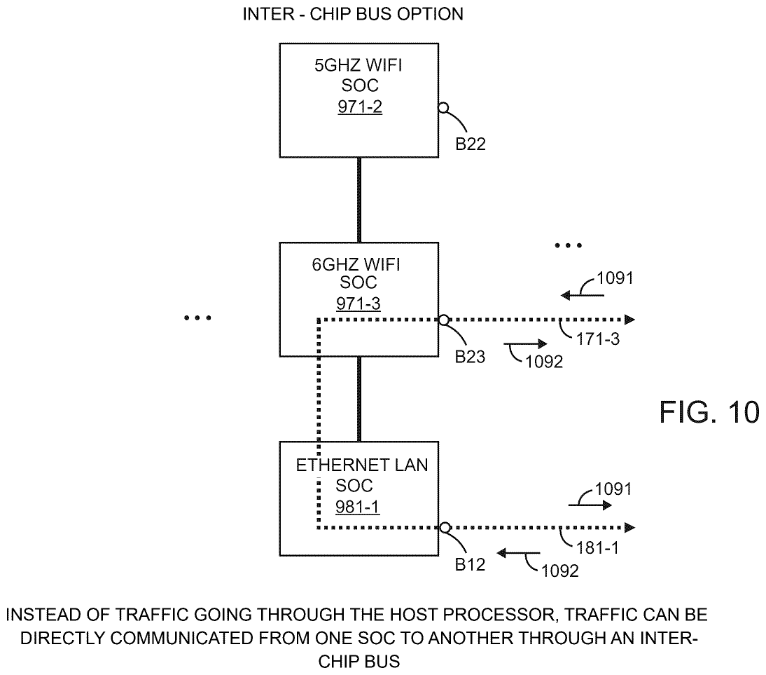

FIG. 10 is an example diagram illustrating a so-called inter-chip bus option as discussed herein.

In this example, the communication management resource 140 is configured to receive communications 1091 from the port B23 associated with the communication interface 971-3. Based on the received communications 1091, the communication interface 971-3 forwards the communications 1091 directly to the communication interface 981-1 without passing through the host processor 940. The communication interface 981-1 then transmits the received communications 1091 through the B12 and over the wire communication link 181-1 for delivery to a destination network address as specified by the received communications 1091.

In a reverse direction, the port B12 can be configured to receive communications 1092 from the network 191 and wired communication link 181-11. Based on the received communications 1092, the communication interface 981-1 forwards the communications 1092 directly to the communication interface 971-3 without passing through the host processor 940. The communication interface 971-2 then transmits the received communications 1092 through the port B23 and over the wireless communication link 171-3 for delivery to a destination network address and application as specified by the received communications 1092.

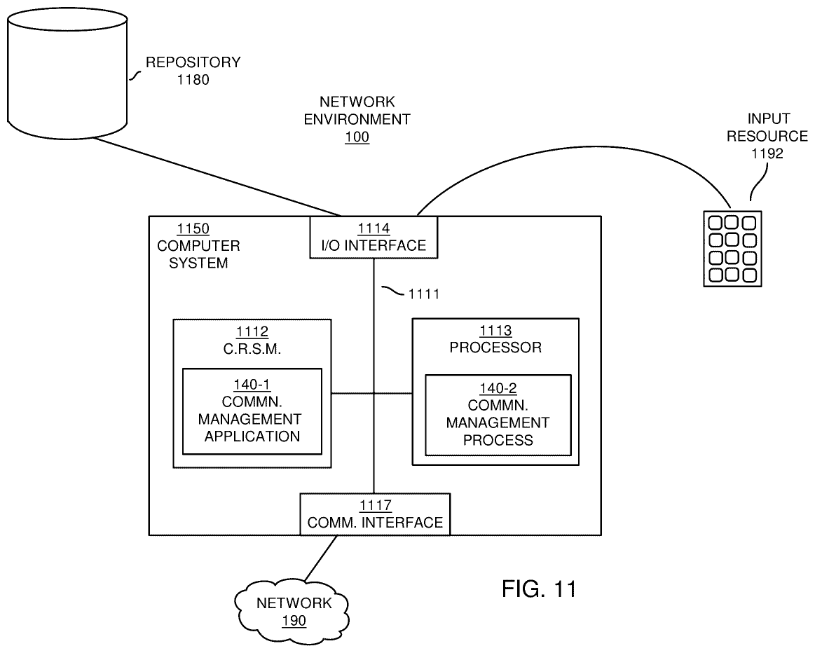

FIG. 11 is an example block diagram of a computer system for implementing any of the operations as previously discussed according to examples herein.

Note that any of the resources (such as communication management resource 140, wireless access point, port B11, port B12, . . . , port B21, . . . , port B23, any communication interface, host processor 940, arbiter 810, upper processing layers, lower processing layers, etc.) as discussed herein can be configured to include computer processor hardware and/or corresponding executable instructions to carry out the different operations as discussed herein.

For example, as shown, computer system 1150 of the present example includes interconnect 1111 coupling computer readable storage media 1112 such as a non-transitory type of media or computer readable storage hardware (which can be any suitable type of resource in which digital information can be stored and/or retrieved), a processor 1113 (computer processor hardware), I/O interface 1114, and a communications interface 1117.

I/O interface(s) 1114 supports connectivity to repository 1180 and input resource 1192.

Computer readable storage medium 1112 can be any hardware storage device such as memory, optical storage, hard drive, floppy disk, etc. In one example, the computer readable storage medium 1112 (computer readable storage hardware) stores instructions and/or data.

As shown, computer readable storage media 1112 can be encoded with communication management application 140-1 (such as instantiation of communication management resource 140 or other functions as discussed herein) in a respective one or more network nodes to carry out any of the operations as discussed herein.

During operation of one example, processor 1113 accesses computer readable storage media 1112 via the use of interconnect 1111 in order to launch, run, execute, interpret or otherwise perform the instructions in management application 140-1 stored on computer readable storage medium 1112. Execution of the management application 140-1 produces management process 140-2 to carry out any of the operations and/or processes as discussed herein.

Those skilled in the art will understand that the computer system 1150 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein.

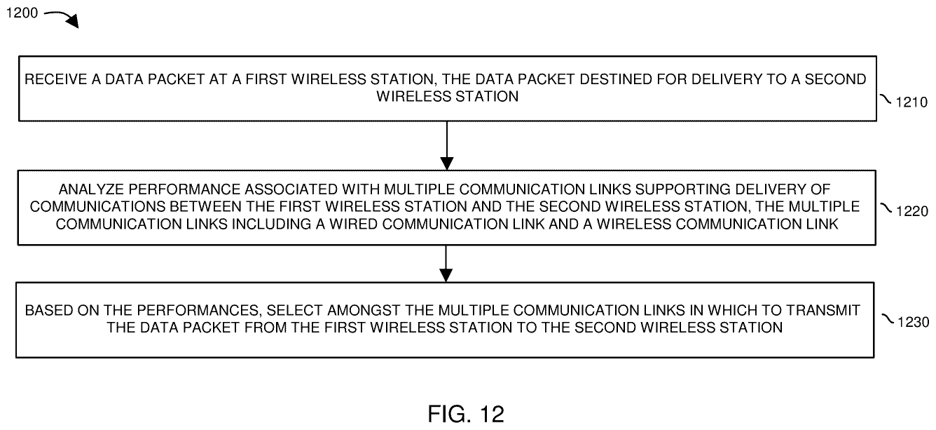

Functionality supported by the different resources will now be discussed via flowchart 1200 in FIG. 12. Note that the steps in the flowcharts below can be executed in any suitable order.

FIG. 12 is a flowchart 1200 illustrating an example method according to examples herein. Note that there will be some overlap with respect to concepts as discussed above.

In processing operation 1210, the communication management resource 140 receives a data packet at a first wireless station. The data packet is destined for delivery to a second wireless station.

In processing operation 1220, the communication management resource 140 analyzes performance associated with multiple communication links supporting delivery of communications between the first wireless station and the second wireless station. The multiple communication links include a wired communication link and a wireless communication link.

In processing operation 1230, based on the performances, the communication management resource 140 selects amongst the multiple communication links in which to transmit the data packet from the first wireless station to the second wireless station.

Note again that techniques herein are well suited to facilitate conveyance of more efficient communications between a first wireless station and the second wireless station in a network environment. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

I claim:

1. A method comprising:
receiving a data packet at a first wireless station, the data packet destined for delivery to a second wireless station;
analyzing performance associated with multiple communication links supporting delivery of communications between the first wireless station and the second wireless station, the multiple communication links including a wired communication link and a wireless communication link; and
based on the performances, selecting amongst the multiple communication links in which to transmit the data packet from the first wireless station to the second wireless station.

2. The method as in claim 1, wherein selecting amongst the multiple communication links includes: selecting the wireless communication link to transmit the data packet from the first wireless station to the second wireless station in response to detecting that the wireless communication link supports better performance of conveying data to the second wireless station than the wired communication link, the method further comprising:
transmitting the data packet over the wireless communication link to the wireless station.

3. The method as in claim 1, wherein selecting amongst the multiple communication links includes: selecting the wired communication link to transmit the data packet from the first wireless station to the second wireless station in response to detecting that the wired communication link supports better performance of conveying data to the second wireless station than the wireless communication link, the method further comprising:
transmitting the data packet over the wired communication link to the wireless station.

4. The method as in claim 1 further comprising:
implementing an upper processing layer at the first wireless station to receive and process the data packet, the upper processing layer in communication with a first lower processing layer associated with the wired communication link and a second lower processing layer associated with the wireless communication link.

5. The method as in claim 4 further comprising:
processing the data packet at the upper processing layer;
selecting the wired communication link for transmission of the data packet from the first wireless station to the second wireless station; and
communicating the data packet over the wired communication link.

6. The method as in claim 1, wherein the wired communication link provides a bypass path with respect to the wireless communication link for communicating the data packet from the first wireless station to the second wireless station.

7. The method as in claim 1, wherein the wired communication link is a wired local area network;
wherein the first wireless station is a first terminal node in the wired local area network; and
wherein the second wireless station is a second terminal node in the wired local area network.

8. The method as in claim 1 further comprising:
monitoring a respective performance associated with each of the multiple communication links; and
producing the performance information ranking the multiple communication links based on the respective performance.

9. The method as in claim 8, wherein analyzing the performance associated with the multiple communication links includes: analyzing the performance information to determine which of the multiple communication links provides a best performance of communicating between the first wireless station and the second wireless station.

10. The method as in claim 1, wherein the first wireless station is a wireless access point; and
wherein the second wireless station is a stationary computer device.

11. A system comprising:
communication management hardware operative to:
receive a data packet at a first wireless station, the data packet destined for delivery to a second wireless station;
analyze performance associated with multiple communication links supporting delivery of communications between the first wireless station and the second wireless station, the multiple communication links including a wired communication link and a wireless communication link; and
based on the performances, select amongst the multiple communication links in which to transmit the data packet from the first wireless station to the second wireless station.

12. The system as in claim 11, wherein the communication management hardware is further operative to:
select the wireless communication link to transmit the data packet from the first wireless station to the second wireless station in response to detecting that the wireless communication link supports better performance of conveying data to the second wireless station than the wired communication link, the method further comprising:
transmitting the data packet over the wireless communication link to the wireless station.

13. The system as in claim 11, wherein the communication management hardware is further operative to:
select the wired communication link to transmit the data packet from the first wireless station to the second wireless station in response to detecting that the wired communication link supports better performance of conveying data to the second wireless station than the wireless communication link, the method further comprising:
transmit the data packet over the wired communication link to the wireless station.

14. The system as in claim 11, wherein the communication management hardware is further operative to:
implement an upper processing layer at the first wireless station to receive and process the data packet, the upper processing layer in communication with a first lower processing layer associated with the wired communication link and a second lower processing layer associated with the wireless communication link.

15. The system as in claim 14, wherein the communication management hardware is further operative to:
process the data packet at the upper processing layer;
select the wired communication link for transmission of the data packet from the first wireless station to the second wireless station; and
communicate the data packet over the wired communication link.

16. The system as in claim 11, wherein the wired communication link provides a bypass path with respect to the wireless communication link for communicating the data packet from the first wireless station to the second wireless station.

17. The system as in claim 11, wherein the wired communication link is a wired local area network;
wherein the first wireless station is a first terminal node in the wired local area network; and
wherein the second wireless station is a second terminal node in the wired local area network.

18. The system as in claim 11, wherein the communication management hardware is further operative to:
monitor a respective performance associated with each of the multiple communication links; and
produce the performance information ranking the multiple communication links based on the respective performance.

19. The system as in claim 11, wherein the communication management hardware is further operative to:
analyze the performance information to determine which of the multiple communication links provides a best performance of communicating between the first wireless station and the second wireless station.

20. The system as in claim 11, wherein the first wireless station is a wireless access point; and
wherein the second wireless station is a stationary computer device.

21. Computer-readable storage hardware having instructions stored thereon, the instructions, when carried out by computer processor hardware at a first wireless station, cause the computer processor hardware to:
receive a data packet destined for delivery to a second wireless station;
analyze performance associated with multiple communication links supporting delivery of communications between the first wireless station and the second wireless station, the multiple communication links including a wired communication link and a wireless communication link; and
based on the performances, select amongst the multiple communication links in which to transmit the data packet from the first wireless station to the second wireless station.
